(19) United States
(12) Patent Application Publication
(10) Pub. No.: US 2024/0100588 A1
(43) Pub. Date: Mar. 28, 2024

(54) Method and device for the production of three-dimensional objects

(71) Applicant: Kurtz GmbH & Co. KG, Kreuzwertheim (DE)

(72) Inventors: Uwe Rothaug, Marktheidenfeld (DE); Victor Romanov, Wertheim (DE)

(21) Appl. No.: 17/767,498

(22) PCT Filed: Oct. 9, 2020
(86) PCT No.: PCT/EP2020/078504

§ 371 Date: Apr. 8, 2022

(30) Foreign Application Priority Data
Oct. 9, 2019 (DE) 10 2019 127 191.6

(51) Int. Cl. B22C 9/02; B33Y 10/00; B33Y 30/00; B33Y 80/00; C04B 40/02; H05B 6/62

(52) U.S. Cl. CPC B22C 9/02; B33Y 10/00; B33Y 30/00; B33Y 80/00; C04B 40/0213; H05B 6/62; C04B 2111/00181

(57) ABSTRACT

The invention relates to a method and to a device for generating three-dimensional objects by means of a generative method. According to the invention, powdered material and binding agents are applied sequentially and electromagnetic waves are used to cure the binding agent so that the powdered material bonded with the binding agent forms the three-dimensional object. The electromagnetic waves used are RF radiation. As a result, a fast and uniform curing of the three-dimensional object is achieved.

The present invention relates to a method and a device for the production of three-dimensional objects, in particular by means of a generative method. The present invention relates in particular to a method and a device for the production of sand moulds and sand cores.

By means of generative production methods it is possible to produce a wide variety of three-dimensional parts with complex geometry.

With generative production, three-dimensional workpieces for example are built up in layers. The build-up takes place under computer control, from one or more liquid or solid materials, according to preset dimensions and shapes (CAD), and involves physical or chemical curing or melting processes. Typical materials for generative production are plastics, synthetic resins, ceramics and metals. Generative production is also described as 3D printing or additive manufacturing. The corresponding devices are described as 3D printers.

3D printers are used in industry and in research. In addition, there are also applications in the home and entertainment sectors and in the arts.

voxeljet technology GmbH (https://www.voxeljet.com/de/anwendungen/sandguss/) offers a service for the production of sand moulds and sand cores for metal casting. This involves quartz sand being applied in layers and selectively bonded to a binder, until the desired mould is obtained. Depending on the requirement and the application, a choice may be made between different binders and sands, in order to obtain optimal casting results.

To produce sand moulds, binder materials customary in casting, such as furan and phenolic resins, or also inorganic binder materials, are used. As a result, even large formats up to 4 m long, 2 m wide and 1 m high are possible.

In the “Taschenbuch der Giessereipraxis 2019” [Manual of Foundry Practice], pages 153-158, generative production methods in casting practice are described. To make possible the production from sand of sand moulds or sand cores using the generative method, on the one hand binder jetting (3D printing of powdery material with binder) and also multi jet modelling (MDM) are proposed. Both methods may be executed as powder bed processes. Multi jet modelling may however also be implemented by solid free-form fabrication (Freiraumverfahren), in which a mixture of sand and binder is sequentially pressed in the desired mould. Binder jetting is a generative production process, in which a liquid binder is applied in a targeted manner on to a powdery layer, so as to bond with the material. Sections of the material layers are bonded by this means, so as to form an object. Spraying-on of the binder is similar to the conventional inkjet printing process. For binding the sand, various binding materials are known, such as furan binder, phenol binder, silicate binder or polymer binder. Curing of the binder material is effected by heating using microwave radiation.

The generative production of sand moulds and sand cores has proved very successful since, on the one hand, it is very cost-efficient (no model costs, short throughput times, low modification costs), the moulds may have structures of any desired complexity without generating additional costs, the moulds and cores are of high quality and may be made to a large size and with low tolerances. Furthermore, expensive and heavy moulds and cores may be stabilised by reinforcements.

EP 3,266, 815 A1 discloses a radiation-curable binder material for the forming of sand cores. The curing of sand cores is here generated by so-called actinic radiation, wherein the radiation produces a photochemical effect. Actinic radiation is a typical mode of electromagnetic radiation in the optical or UV sector.

US 2018/0361618 A1 discloses a method for the printing of three-dimensional bodies from a powdery material, wherein a liquid functional material designed to absorb electromagnetic waves is added. The liquid functional material contains ferromagnetic nano-particles and is thus able to generate temperatures of 60° C. to 2500° C. In this way the powdery material, which may be for example silicon dioxide, is melted. The energy is applied by means of microwaves or RF radiation.

Described in DE 697 13 775 Part 2 is a hybrid oven and a method in which microwaves and RF radiation may be applied to objects simultaneously.

The invention is based on the problem of creating a method and a device for the production of three-dimensional objects by means of a generative process in which a powdery material and binder are applied sequentially and the binder is cured by electromagnetic waves, wherein this method is especially suitable for the production of large-scale three-dimensional objects or for the simultaneous production of many objects in an extensive processing area.

The problem is solved by the subjects of the independent patent claims. Advantageous developments are set out in the relevant dependent claims.

The method according to the invention is a method for the production of three-dimensional objects by means of a generative process in which a powdery material and binder are applied sequentially and the binder is cured by electromagnetic waves, so that the powdery material bonded by the binder forms the three-dimensional object.

This method is characterised in that RF radiation is used as electromagnetic waves.

Since RF radiation has a long wavelength, a large volume of binder may be activated by the radiation simultaneously. At a frequency of 300 MHz, the wavelength is around 1 m. At the frequency for industrial applications of 27.12 MHz usual in Germany, the wavelength amounts to around 11 m. If standing waves form in the moulding tool, then it is possible to provide a wavelength with a half-wave which is distinctly longer than the dimensions of the three-dimensional object to be produced. In this way it is possible to ensure that a wave node of a standing wave is located outside a processing area in which the three-dimensional object is produced. By this means, uniform curing of the three-dimensional object is obtained. Both localised overheating, in which binder could be destroyed, and areas in which the binder is not adequately stimulated, are avoided. With the use of microwave radiation there is on the other hand the problem that, owing to the short wavelength in the case of standing waves, certain areas are only lightly stimulated, so that the binder is not cured and the powdery material is not bonded. To make possible the production of three-dimensional objects with a size of up to 3 m and with high quality, it is recommended that RF radiation with a frequency of no more than 50 MHz and in particular no more than 40 MHz is used.

The use of RF radiation also effects complete penetration of the powdery material and the binder, so that a three-dimensional object may be cured at once. If the binder is excited by means of infrared light, this can penetrate only in the surface area of the powdery material. When infrared light is used it is essential that, after each application of a thin layer of powdery material and binder, the latter is irradiated with infrared light. This is not necessary with the use of RF radiation, so that the process may be carried out with much greater speed.

Curing by means of RF radiation may take place in sections, or a three-dimensional object may also be cured all at once (one shot).

The uniform and complete penetration of the object to be produced results on the one hand in high quality and on the other hand in rapid production of the object, so that production costs may be reduced considerably as compared with conventional methods.

The additive generation of the three-dimensional object is preferably made between two capacitor plates which are connected to an RF generator. By this means the RF radiation may be applied to the not yet cured three-dimensional object, without the need for the latter to be moved. In the context of the invention it is however in principle also possible to move the generatively produced three-dimensional object, before it has been cured, in the area between two capacitor plates, by which the three-dimensional object is subjected to RF radiation. If the generative production of the three-dimensional object is effected using the powder bed method, in which layers of the powdery material are placed on top of one another, and only the areas or sections to be cured are provided with binder, then preferably the whole layer structure is moved in the area between the two capacitor plates. After curing, the powdery material which is not provided with binder is removed from the three-dimensional object. Before curing it serves to support the not yet cured three-dimensional object.

The powdery material is preferably applied in layers, as known from the powder bed method. In principle it is also possible within the scope of the invention to press a viscous mixture of powdery material and binder in solid free-form fabrication.

The layers are preferably applied with a thickness of no more than 1 mm and in particular no more than 500 μm and in particular no more than 300 μm. The thinner the layers applied, the finer may be the contour of the three-dimensional object. The thinner the individual layers, the more layers are needed to produce an object of predetermined thickness. Consequently, the production of the three-dimensional object with thinner layers takes longer than with thicker layers. With the layer-by-layer application of the powdery material, the binder is sprayed on to the layer only in predetermined areas which are to form the three-dimensional object.

Using the method it is possible to produce as three-dimensional object a sand core or a sand mould for metal casting, with sand as powdery material being bonded by means of the binder to form the three-dimensional object.

The powdery material for producing a sand core or a sand mould is a fireproof, particle-shaped moulding base material, described below in abbreviated form as “sand”. The particle-shaped fireproof moulding base material may comprise silicon dioxide (quartz sand), metal oxide, a ceramic material, or even glass, or a mixture thereof. Irrespective of the chemical composition, this particle-shaped fireproof moulding base material is described as sand.

Suitable binding agents may be binders based on furan, phenol, silicon or a polymer.

The sand core or sand mould may also be made by shooting into a sand mould. Here, curing of the sand mould is effected in the same way as explained above with the aid of the three-dimensional generatively moulded objects, by means of RF radiation.

Three-dimensional objects of any kind may be made by shooting a mixture of a powdery material and binder into a mould and curing by RF radiation.

The benefits described above for the curing of the three-dimensional object apply irrespective of the nature of the moulding of the body. In particular, with RF radiation, one-shot curing is possible, wherein the three-dimensional object may have a large volume, e.g. at least 0.01 m³ or at least 0.1 m³ or even at least 1 m³.

Generative production in conjunction with curing by RF radiation is however preferred since, on the one hand, three-dimensional objects may be made in any desired form, and may be fixed in their form, by curing with RF radiation, rapidly, reliably and completely.

The electromagnetic RF radiation has preferably a frequency of at least 30 KHz or at least 0.1 MHz, in particular at least 1 MHz or at least 2 MHz, preferably at least 10 MHz.

The electromagnetic RF radiation has preferably a maximum frequency of 300 MHz.

The invention also relates to a device for the production of three-dimensional objects by means of a generative method, comprising
an application device for sequential application of powdery material
an application device for the application of binder
an RF generator to generate RF radiation, and
two capacitor plates to apply the RF radiation to the applied mixture of powdery material and binder.

The device may have a process area which is formed between the capacitor plates, wherein an electrically conductive chamber wall is provided to shield the process area during application of the RF radiation. By this means, defined RF radiation is provided in the process area, and the environment is not burdened by electromagnetic radiation.

The application device for application of binder may be either a spray nozzle, or a nozzle for applying a mixture of powdery material and binder. With a nozzle for the application of such a mixture, the mixture may be applied in the solid free-form fabrication method.

The invention is described in detail below, by way of example, with the aid of the drawings.

The drawings show in:

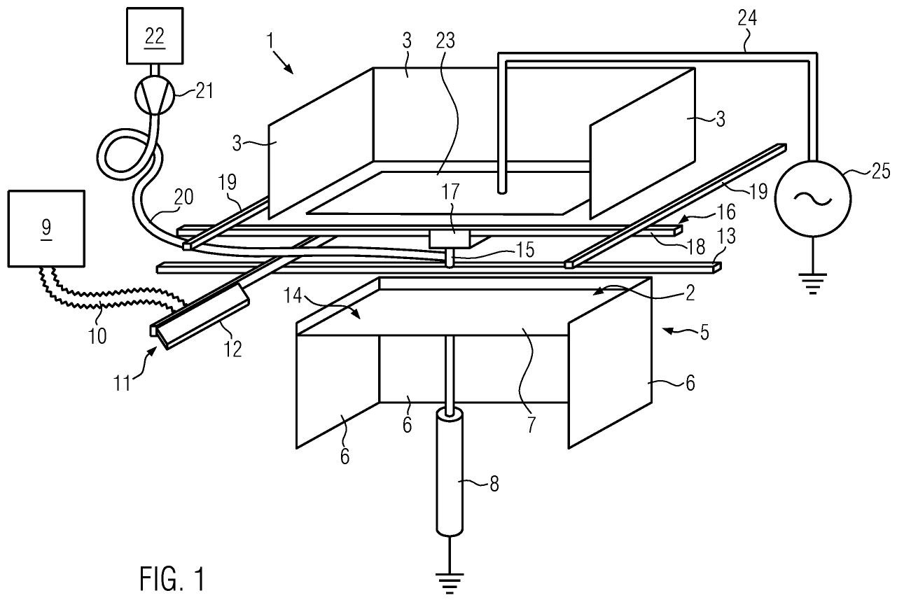

FIG. 1: a binder jetting device with opened process area in a perspective sectional view in which the front elements are cut away, so that important parts of the device are visible, and

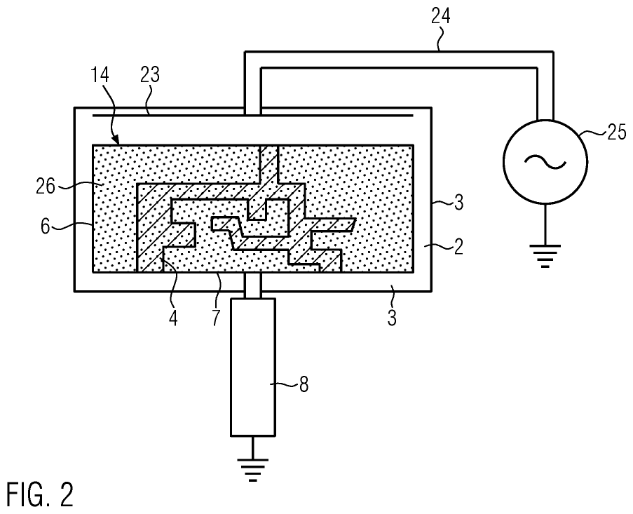

FIG. 2: the device of FIG. 1 in a sectional view, in which the process area is closed and, for simplification, the image of a spray nozzle and its positioning device, together with an application device, are omitted.

A device 1 for the generative production of a three-dimensional object is explained below by way of example (FIGS. 1 and 2).

The present embodiment is a so-called binder jetting device 1 with powder bed feed, for the production of sand moulds and sand cores. The binder jetting device 1 comprises a process area 2 which is sealed from the outside by chamber walls 3. At least one and preferably all chamber walls may be slid or pivoted up or down, so that the process area 2 may be bounded on one side by the chamber walls 3 (FIG. 2) and on the other side the chamber walls may be removed, so that the process area 2 is freely accessible at least from one side. The chamber walls 3 are electrically conductive. The process area 2 serves as the building area for the three-dimensional part 4 (FIG. 2).

Provided in the process area 2 is a container 5, open towards the top. This container 5 is made of four vertically arranged side walls 6, in which is located a horizontal building platform 7 to accommodate the part to be produced. In FIG. 1, due to the sectional view, only three side walls are visible.

The building platform 7 has a piston/cylinder unit as height adjustment mechanism 8, by means of which the building platform 7 is adjustable vertically.

The device 1 also includes a storage tank 9, designed to hold a powdery starting material which may be solidified, for example sand.

The storage tank 9 is connected by a flexible tube 10 to an application device 11. The application device 11 serves to bring the base material up to the building platform 7. The application device is a coating device, with which layers of predetermined thickness may be applied consecutively to the building platform 7. The application device 11 has a slit-shaped nozzle 12, with which the powdery material from the storage tank 9 may be applied in a thin layer over the whole width of the building platform 7. For this purpose the application device 11 is mounted slidably on rails 13, so that the application device 11 can cover the whole area across the building platform 7 and may also be arranged a short distance outside the area of the chamber walls 3 (FIG. 1). The rails 13 (owing to the partial section, only one of the rails 13 is shown in FIG. 1) are also arranged outside the area of the chamber walls 3, so that they do not obstruct the chamber walls 3 when the latter are lowered.

A working plane 14 is the plane in which in each case the surface of the topmost layer of the powdery material to be solidified is to be found. The height adjustment mechanism 8 is preferably so controlled that the working plane 14 always lies at the same level or within a predetermined level area.

In addition, a spray nozzle 15 is arranged in the area above the working plane 14, which is freely traversable in a plane parallel to the working plane by a positioning device 16. The positioning device 16 has a slide 17 on which the spray nozzle 15 is mounted. The slide 17 is movably mounted on a rail 18. The rail 18 is in turn movably mounted on two rails 19 in a plane parallel to the working plane 14 in a direction transverse to its longitudinal direction, so that on the one hand the spray nozzle 15 can cover the whole area over the building platform 7, and on the other hand the whole positioning device 16 may be moved out of the process area 2.

The spray nozzle 15 is aligned with its nozzle orifice vertically downwards and connected to a binder line 20 with a pump 21 and a binder storage tank 22. The spray nozzle 15 is so designed that it directs a fine jet of binder vertically downwards. In principle it is also possible to provide several spray nozzles, which may all be identical or also so designed that they deliver the binder in spray cones of differing size.

In the case of several spray nozzles, certain spray nozzles may be assigned only to specific segments above the working plane 14. The spray nozzles may be mounted in each case on freely oscillating robot arms or on a rail system with several rails, so that several spray nozzles may be positioned independently of one another.

The building platform 7 is made of an electrically conductive material and earthed via the height adjustment mechanism 8. The side walls 6 of the container 5 are made of an electrically non-conductive material.

The process area 2 is bounded towards the top by an electrically conductive top panel 23, which is connected by a waveguide 24 to an RF generator 25 for generating RF radiation. RF radiation has a frequency of at least 30 KHz and a maximum of 300 MHz. In the present embodiment, the RF generator is designed to emit a frequency of 27.12 MHz. The specific frequency to be used depends on local statutory regulations which as a rule allow only certain RF frequencies for civil use in production processes.

The mode of operation of the binder jetting device 1 described above is outlined below.

Using the application device 11, a thin layer of sand is applied to the building platform 7. The sand, in particular quartz sand, is for this purpose drawn from the storage tank 9 through the tube 10 and distributed evenly over the building platform 7 by means of the nozzle 12. The layers are applied preferably with a thickness of no more than 1 mm and in particular no more than 500 μm. They may however also be applied even more finely, as for example with a maximum thickness of 300 μm.

The areas of the layers which are to be cured are sprayed with a binder using the spray nozzle 15. For binding sand, in particular quartz sand, various binders such as for example binders based on furan or phenol, silicate binders or polymers, may be used. For this purpose the binder is conveyed by the pump 21 from the binder storage tank 22 to the spray nozzle 15.

Application of a sand layer and area-by-area spraying of the sand layer with binder is repeated until a layer structure 26 (FIG. 2) with the desired height is obtained, in which the three-dimensional part 4 to be manufactured is formed, in which the relevant sand bodies are wetted with binder. Here it is possible to produce three-dimensional parts 4 with any desired contour and undercuts as required in a working process which is scarcely possible with non-generative production methods.

If the layer structure 26 is completely formed, then the application device 11 and the spray nozzle 15 are removed from the process area 2 and the chamber walls 3 which enclose the process area 2 on all sides are lowered. The chamber walls 3 are preferably made of an electrically conductive material and are in contact neither with the top panel 23 nor the building platform 7. The side walls 6 of the container 5 are made of a non-electrically conductive material.

With the RF generator 25, RF radiation is applied in the area between the building platform 7 and the top panel 23 by means of the waveguide 24. The building platform 7 and the top panel 23 serve as capacitor plates. The electrically conductive chamber walls 3 shield the electrical field from the outside. Since the side walls 6 of the container 5 are non-electrically conductive, they do not impair the electromagnetic field within the capacitor formed by the building platform 7 and the top panel 23.

In the present embodiment, the top panel 23 is stationary, i.e. immovable. Within the scope of the invention it may also be expedient for the top panel to be adjustable in height so that, after application of the sand layers and removal of the application device 11 and the spray nozzle 15 from the process area 2, the top panel 23 is lowered a little, so that the volume of the capacitor, comprised of the building platform 7 and the top panel 23, is kept as small as possible. If the top panel 23 is designed so that it can be lowered, then either the waveguide 24 is to be provided with a telescopic section, which has a variable length in the vertical direction, or a flexible coaxial cable is used as waveguide 24. With high electric power it is however expedient to provide a static coaxial conductor as waveguide 24.

In this method, the three-dimensional part 4 is cured all at once in the entire layer structure 26.

After curing of the three-dimensional part 4, it may be removed from the container 5, while the non-bonded sand may be simply separated from the three-dimensional part 4.

The embodiment described above serves for the production of sand cores and sand moulds. With this method, other powdery materials with binder may also be made into three-dimensional parts.

With the method described above, the layers of powdery material may be built up consecutively and sequentially to form a layer structure 26 corresponding to the powder bed method. Within the scope of the invention it is also possible that a viscous mixture of powdery materials and binder may be pressed by means of suitable pressure nozzles in accordance with the solid free-form fabrication method.

The use of RF radiation effects on the one hand a complete and even curing of the whole three-dimensional part 4 and also on the other hand a very rapid curing, since this may be effected in a single process stage or in a few process steps.

In the embodiment described above, an application device 11 with a nozzle 12 is used for the application of sand. Within the scope of the invention, other application devices, e.g. a squeegee, may also be used, to spread the powdery material in a thin layer and where applicable, to compact it. With such an application device a storage tank for the powdery material, open at the top, and from which the powdery material is withdrawn, is arranged next to the container 5.

A three-dimensional object may also be made by shooting a mixture of powdery material and binder into a mould, and curing it by RF radiation. Here a capacitor may be used to apply the RF radiation, as described above. The uncured object is placed in the capacitor and there subjected to RF radiation.

Shooting may also be used to produce a sand core or a sand mould.

### LIST OF REFERENCE NUMBERS

1 binder jetting device
2 process area
3 chamber wall
4 three-dimensional part
5 container
6 side wall
7 building platform
8 height adjustment mechanism
9 storage tank
10 tube
11 application device
12 nozzle
13 rail
14 working plane
15 spray nozzle
16 positioning device
17 slide
18 rail
19 rail
20 binder line
21 pump
22 binder storage tank
23 top panel
24 waveguide
25 RF generator
26 layer structure

1. Method for the production of three-dimensional objects by means of a generative process in which a powdery material and binder are applied sequentially and the binder is cured by electromagnetic waves, so that the powdery material bonded by the binder forms the three-dimensional object,
wherein RF radiation is used as electromagnetic waves.

2. Method according to claim 1,
wherein curing by means of RF radiation takes place in sections, or a complete three-dimensional object is cured all at once.

3. Method according to claim 1,
wherein additive generation of the three-dimensional object is made between two capacitor plates which are connected to an RF generator.

4. Method according to claim 1,
wherein the powdery material is applied in the form of layers.

5. Method according to claim 4,
wherein the layers have a thickness of no more than 1 mm and preferably no more than 500 μm and in particular no more than 300 μm.

6. Method according to claim 4,
wherein the binder is sprayed on to the layer in predetermined areas.

7. Method according to claim 1,
wherein a mixture of powdery material and binder is pressed.

8. Method for the production of a sand core or a sand mould, in which the sand core or the sand mould are either produced as a three-dimensional object, by bonding sand as powdery material by means of a binder to form a three-dimensional object, or the sand core or the sand mould is made by shooting into a mould, wherein a mixture of sand and binder is shot into the mould and the sand core or sand mould is cured by RF radiation.

9. Device for the production of three-dimensional objects by means of a generative method, comprising
an application device for sequential application of powdery material
an application device for the application of binder
an RF generator to generate RF radiation, and
two capacitor plates to apply the RF radiation to the applied mixture of powdery material and binder.

10. Device according to claim 9,
wherein the device has a process area which is formed between capacitor plates, wherein an electrically conductive chamber wall is provided, which shields the process area during application of the RF radiation.

11. Device according to claim 9,
wherein the application device to apply binder is either a spray nozzle or
a nozzle to apply a mixture of powdery material and binder.

12. Device for the production of three-dimensional objects by means of a generative method, comprising
an application device for sequential application of powdery material
an application device for the application of binder
an RF generator to generate RF radiation, and
two capacitor plates to apply the RF radiation to the applied mixture of powdery material and binder,
wherein the device is designed to implement a method according to claim 1.
